(19) United States
(12) Patent Application Publication
(10) Pub. No.: US 2026/0203057 A1
(43) Pub. Date: Jul. 16, 2026

(54) METHOD AND DEVICE WITH CODE CONVERSION

(71) Applicant: SAMSUNG ELECTRONICS CO., LTD., Suwon-si (KR)

(72) Inventors: Kyoung-ho SON, Suwon-si (KR); Hoyeon PARK, Suwon-si (KR); Jihoon LEE, Suwon-si (KR); Sungwon JEONG, Suwon-si (KR); Eun JUNG, Suwon-si (KR)

(73) Assignee: SAMSUNG ELECTRONICS CO., LTD., Suwon-si (KR)

(21) Appl. No.: 19/259,069

(22) Filed: Jul. 3, 2025

(30) Foreign Application Priority Data
Jan. 14, 2025 (KR) 10-2025-0005493

(51) Int. Cl. G06F 8/76; G06F 8/41

(52) U.S. Cl. CPC G06F 8/76; G06F 8/427

(57) ABSTRACT

An electronic device includes: one or more processors and a memory storing instructions, wherein the instructions, when executed by the one or more processors, cause the electronic device to: obtain first code configured for an advanced reduced instruction set computer (RISC) machine (ARM) architecture; determine a conversion target portion of the first code based on a standard item of the ARM architecture and a corresponding item of a RISC-V architecture; and generate second code based on the RISC-V architecture by performing, on the conversion target portion, a conversion operation selected based on an association between the standard item and the corresponding item, wherein the conversion operation is a code substitution operation for at least a part of the conversion target portion, a code modification operation, or a presentation operation of including in the second code an implementation guide guiding conversion of the target portion.

### CROSS-REFERENCE TO RELATED APPLICATIONS

This application claims the benefit under 35 USC § 119 (a) of Korean Patent Application No. 10-2025-0005493, filed on Jan. 14, 2025, in the Korean Intellectual Property Office, the entire disclosure of which is incorporated herein by reference for all purposes.

### BACKGROUND

### 1. Field

The following description relates to a method and device for providing second code based on a reduced instruction set computer (RISC)-V architecture, a fifth generation of RISC architecture, converted from software code based on an advanced RISC machine (ARM) architecture, based on a relationship between a standard item of the ARM architecture and a corresponding item of the RISC-V architecture.

### 2. Description of Related Art

An instruction set architecture (ISA) is a standard that defines an interface between hardware and software of a computing system, typically defined by the opcodes, operands/parameters of instructions, etc. For example, a complex instruction set computer (CISC) (e.g., x86) ISA has a complex instruction set, and a reduced instruction set computer (RISC) (e.g., advanced RISC machine (ARM) architecture and RISC-V architecture) has a simple instruction set. Among the above, RISC ISAs have a simple instruction structure and use a fixed instruction length, so are widely used in embedded systems that require a low-power and high-efficiency design. However, processors implementing an ISA for the widely used ARM architecture have the disadvantage of requiring a license fee. On the other hand, the RISC-V architecture, which is a fifth generation of RISC architecture, has the advantage of being an open-source architecture that may be used without paying a license fee. Consequently, there is an increasing demand to convert existing software code based on the ARM architecture to software code based on the RISC-V architecture. Accordingly, many companies and developers are attempting to port existing ARM architecture-based software to RISC-V architecture-based software. However, this is a complex task that is time-consuming and costly because the difference between the two architectures requires meticulous optimization and reconfiguration rather than simple code conversion. Currently, this method of relying on manual by developers with different capabilities has various limitations such as time and cost efficiency, as well as technical accuracy. Therefore, there is a growing need for a system that may automatically convert ARM-based software code to RISC-V-based software code.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an electronic device includes: one or more processors and a memory storing instructions, wherein the instructions, when executed by the one or more processors, cause the electronic device to: obtain first code configured for an advanced reduced instruction set computer (RISC) machine (ARM) architecture; determine a conversion target portion of the first code based on a standard item of the ARM architecture and a corresponding item of a RISC-V architecture; and generate second code based on the RISC-V architecture by performing, on the conversion target portion, a conversion operation selected based on an association between the standard item and the corresponding item, wherein the conversion operation is a code substitution operation for at least a part of the conversion target portion, a code modification operation, or a presentation operation of including in the second code an implementation guide guiding conversion of the target portion.

The instructions, when executed by the one or more processors, may cause the electronic device to: obtain parsed code, in which the first code is converted into an intermediate representation, by parsing the first code; and determine, from among syntax elements included in the parsed code, a syntax element corresponding to the standard item to be the conversion target portion.

The instructions, when executed by the one or more processors, may cause the electronic device to: when a first conversion level is designated to the association between the corresponding item and the standard item, which corresponds to the syntax element of the conversion target portion, perform the code substitution operation, which substitutes the syntax element with a RISC-V-based syntax element according to the corresponding item; when a second conversion level is designated to the association between the corresponding item and the standard item, which corresponds to the syntax element of the conversion target portion, perform the code modification operation, which modifies the syntax element; and when a third conversion level is designated to the association between the corresponding item and the standard item, which corresponds to the syntax element of the conversion target portion, perform the presentation operation wherein the implementation guide is directed to RISC-V-based code corresponding to the syntax element.

The code substitution operation may include: a first substitution operation, which substitutes a syntax element of the conversion target portion with a corresponding RISC-V-based element at a same code location as a code location of the conversion target portion; or a second substitution operation, which substitutes the corresponding RISC-V-based element for the syntax element of the conversion target portion at a code location in the first code that is different from the code location of the conversion target portion.

The code modification operation may include: a first modification operation to add another code to a syntax element of the conversion target portion; a second modification operation to change part of a syntax of a syntax element of the conversion target portion; a third modification operation to change an entire syntax of a syntax element of the conversion target portion; a fourth modification operation to add code according to an additional logic to the first code; or a fifth modification operation to replace a syntax element of the first code with code according to an additional logic.

The presentation operation may include: a first presentation operation of outputting information including example code analogous to a syntax element of the conversion target portion; or a second presentation operation of outputting information including an implementation concept for a syntax element of the conversion target portion.

The instructions, when executed by the one or more processors, may cause the electronic device to: generate the second code by integrating other portions of the first code with syntax elements that are converted by applying the code substitution operation or the code modification operation to the conversion target portion.

The electronic device may further include: a display, wherein the instructions, when executed by the one or more processors, may cause the electronic device to: display, by the display, progress information indicating a conversion rate of conversion of syntax elements of the conversion target portion.

The instructions, when executed by the one or more processors, may cause the electronic device to: compile the second code into binary code by using a RISC-V compiler; and obtain verification information on the binary code based on a result of execution of the binary code in a RISC-V simulator environment or a RISC-V hardware environment.

In another general aspect, a computing system may include: a server configured to: obtain first code configured for an advanced reduced instruction set computer (RISC) machine (ARM) architecture; determine a conversion target portion of the first code, based on a standard item of the ARM architecture and a corresponding item of a RISC-V architecture; and generate second code based on the RISC-V architecture by performing, on the conversion target portion, a conversion operation selected based on an association between the standard item and the corresponding item, wherein the conversion operation is either a code substitution operation for at least a part of the conversion target portion or is a code modification operation, and a user terminal configured to generate the second code based on the RISC-V architecture by performing, on the conversion target portion, a presentation operation of including in the second code an implementation guide guiding conversion of the target portion, wherein the presentation operation is designated based on the relationship between the standard item and the corresponding item.

In yet another general aspect, a code conversion method is performed by one or more processors, and the code conversion method includes: obtaining first code configured for an advanced reduced instruction set computer (RISC) machine (ARM) architecture; determining a conversion target portion of the first code, based on a standard item of the ARM architecture and a corresponding item of a RISC-V architecture; and generating second code based on the RISC-V architecture by performing, on the conversion target portion, a conversion operation selected based on an association between the standard item and the corresponding item, wherein the conversion operation is a code substitution operation for at least a part of the conversion target portion, a code modification operation, or a presentation operation of including in the second code an implementation guide guiding conversion of the target portion.

The determining of the conversion target portion may include: obtaining parsed code, in which the first code is converted into an intermediate representation, by parsing the first code; and determining, from among syntax elements included in the parsed code, a syntax element corresponding to the standard item to be the conversion target portion.

The generating of the second code may include: when a first conversion level is designated to the relationship between the corresponding item and the standard item, which corresponds to the syntax element of the conversion target portion, performing the code substitution operation, which substitutes the syntax element with a RISC-V-based syntax element according to the corresponding item; when a second conversion level is designated to the association between the corresponding item and the standard item, which corresponds to the syntax element of the conversion target portion, performing the code modification operation, which modifies the syntax element; and when a third conversion level is designated to the association between the corresponding item and the standard item, which corresponds to the syntax element of the conversion target portion, perform the presentation operation wherein the implementation guide is directed to RISC-V-based code corresponding to the syntax element.

The code substitution operation may include: a first substitution operation, which simply substitutes a syntax element of the conversion target portion with a RISC-V-based corresponding element at a same location as a location of the conversion target portion; or a second substitution operation, which inserts the RISC-V-based corresponding element substituted from the syntax element of the conversion target portion at a different location in the first code from the location of the conversion target portion.

The code modification operation may include: a first modification operation to add another code to a syntax element of the conversion target portion; a second modification operation to change part of a syntax of a syntax element of the conversion target portion; a third modification operation to change an entire syntax of a syntax element of the conversion target portion; a fourth modification operation to add code according to an additional logic to the first code; or a fifth modification operation to replace a syntax element of the first code with code according to an additional logic.

The presentation operation may include at least one of: a first presentation operation of outputting information including example code analogous to a syntax element of the conversion target portion; or a second presentation operation of outputting information including an implementation concept for a syntax element of the conversion target portion.

The generating of the second code may include: integrating, with other portions of the first code, syntax elements that are converted by applying, to the conversion target portion, the code substitution operation or the code modification operation.

The code substitution operation or the code modification operation may be performed by accessing a conversion table mapping standard items, including the standard item, of the ARM architecture, to corresponding items, including the corresponding item, of the RISC-V architecture.

The code conversion method may further include: compiling the second code into binary code by using a RISC-V compiler; and obtaining verification information on the binary code based on a result of execution of the binary code in a RISC-V simulator environment or a RISC-V hardware environment.

A non-transitory computer-readable storage medium stores instructions that, when executed by a processor, cause the one or more processors to perform any of the methods.

Other features and aspects will be apparent from the following detailed description, the drawings, and the claims.

### BRIEF DESCRIPTION OF THE DRAWINGS

FIG. 1 illustrates an example of a code conversion operation, according to one or more embodiments.

FIG. 2 illustrates an example of a computing device, according to one or more embodiments.

FIG. 3 illustrates an example of a code conversion method, according to one or more embodiments.

FIG. 4 illustrates an example of a code conversion platform, according to one or more embodiments.

FIG. 5 illustrates an example of mapping information, according to one or more embodiments.

FIG. 6 illustrates an example of mapping information, according to one or more embodiments.

FIG. 7 illustrates an example of a target setting and conversion module, according to one or more embodiments.

FIG. 8 illustrates an example of a conversion target portion setting operation, according to one or more embodiments.

FIG. 9 illustrates an example of a version selection operation, according to one or more embodiments.

FIG. 10 illustrates an example of a conversion operation, according to one or more embodiments.

FIG. 11 illustrates an example of a mapping information management operation, according to one or more embodiments.

FIG. 12 illustrates an example of a build verification operation, according to one or more embodiments.

FIG. 13 illustrates an example of a deployment environment verification operation.

FIG. 14 illustrates an example of a user interface for setting a location of software code, according to one or more embodiments.

FIG. 15 illustrates an example of a user interface for managing mapping information, according to one or more embodiments.

FIG. 16 illustrates an example of a user interface displaying progress information, according to one or more embodiments.

FIG. 17 illustrates an example of a code conversion system, according to one or more embodiments.

Throughout the drawings and the detailed description, unless otherwise described or provided, the same or like drawing reference numerals will be understood to refer to the same or like elements, features, and structures. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known after an understanding of the disclosure of this application may be omitted for increased clarity and conciseness.

The features described herein may be embodied in different forms and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

The terminology used herein is for describing various examples only and is not to be used to limit the disclosure. The articles “a,” “an,” and “the” are intended to include the plural forms as well, unless the context clearly indicates otherwise. As used herein, the term “and/or” includes any one and any combination of any two or more of the associated listed items. As non-limiting examples, terms “comprise” or “comprises,” “include” or “includes,” and “have” or “has” specify the presence of stated features, numbers, operations, members, elements, and/or combinations thereof, but do not preclude the presence or addition of one or more other features, numbers, operations, members, elements, and/or combinations thereof.

Throughout the specification, when a component or element is described as being “connected to,” “coupled to,” or “joined to” another component or element, it may be directly “connected to,” “coupled to,” or “joined to” the other component or element, or there may reasonably be one or more other components or elements intervening therebetween. When a component or element is described as being “directly connected to,” “directly coupled to,” or “directly joined to” another component or element, there can be no other elements intervening therebetween. Likewise, expressions, for example, “between” and “immediately between” and “adjacent to” and “immediately adjacent to” may also be construed as described in the foregoing.

Although terms such as “first,” “second,” and “third”, or A, B, (a), (b), and the like may be used herein to describe various members, components, regions, layers, or sections, these members, components, regions, layers, or sections are not to be limited by these terms. Each of these terminologies is not used to define an essence, order, or sequence of corresponding members, components, regions, layers, or sections, for example, but used merely to distinguish the corresponding members, components, regions, layers, or sections from other members, components, regions, layers, or sections. Thus, a first member, component, region, layer, or section referred to in the examples described herein may also be referred to as a second member, component, region, layer, or section without departing from the teachings of the examples.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein. The use of the term “may” herein with respect to an example or embodiment, e.g., as to what an example or embodiment may include or implement, means that at least one example or embodiment exists where such a feature is included or implemented, while all examples are not limited thereto.

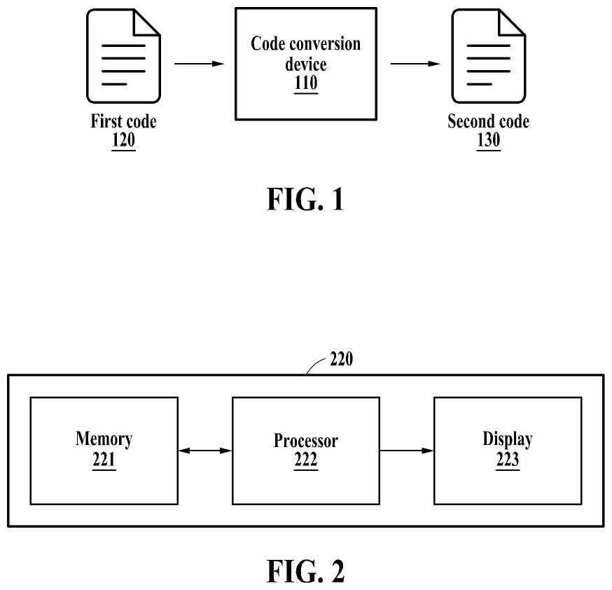

FIG. 1 illustrates an example of a code conversion operation, according to one or more embodiments.

A computing device 110 configured for code conversion may convert first code 120 configured for a first architecture (e.g., an advanced RISC machine (ARM) architecture) to second code 130 configured for a second architecture (e.g., a reduced instruction set computer (RISC)-V architecture). The computing device 110 (e.g., an electronic device) may include a memory and a processor. The first code 120 may include software code (e.g., source code or pre-compiled code (code generated by a precompiler)) compilable for execution by the first architecture (e.g., the ARM architecture). The second code 130 may include software code (e.g., source code or pre-compiled code) compilable for execution by the second architecture (e.g., the RISC-V architecture). A code conversion operation may also be referred to herein as a code conversion method.

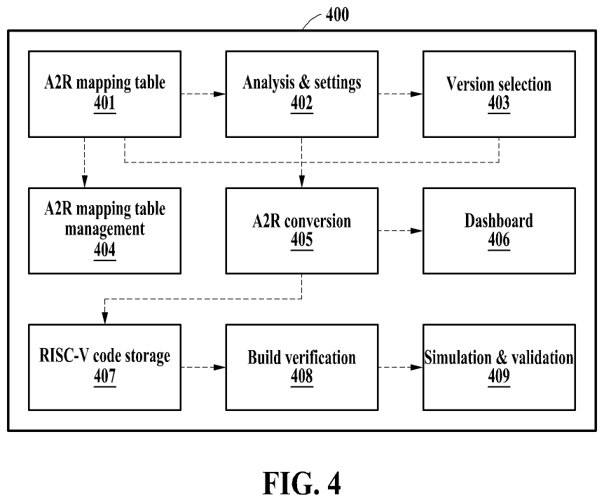

For example, the computing device 110 may obtain the second code 130 from the first code 120 based on mapping information (e.g., a mapping table). The mapping information may indicate relationships between items of the first architecture and items of the second architecture. The mapping information may include, for example, a relationship between a standard item of the first architecture (e.g., the ARM architecture) and a corresponding item of the second architecture (e.g., the RISC-V architecture); such a mapping between a standard item and a corresponding item may include a conversion level for the mapped items. For example, the mapping information may be expressed in a mapping table format that represents the relationship between standard items of the first architecture (e.g., the ARM architecture) and the corresponding items of the second architecture (e.g., the RISC-V architecture) in a table format. The relationships between the standard items of the first architecture and the corresponding items of the second architecture may be organized in various formats. An example of the mapping information is described with reference to FIGS. 4 to 6.

For example, the computing device 110 may provide the second code 130 generated by substituting, among syntax elements included in the first code 120, all or part syntax elements with respectively corresponding standard items included in the mapping information, such substitution items being conformant to the second architecture (e.g., the RISC-V architecture). For example, the computing device 110 may convert a first syntax element (e.g., _breakpoint) in the first code 120 to a second syntax element (e.g., #pragma no_inline) a corresponding second element (e.g., _attribute_((noinline))) in the second code 130.

In this way, the computing device 110 may significantly avoid the time and manpower that would otherwise be required to manually convert code based of the first architecture into code of the second architecture (e.g., the RISC-V architecture) by automatically performing the code conversion operation. In addition, the computing device 110 may avoid the errors typically caused by human error during a code conversion process between architectures by automatically performing the code conversion operation.

FIG. 2 illustrates an example of a computing device, according to one or more embodiments.

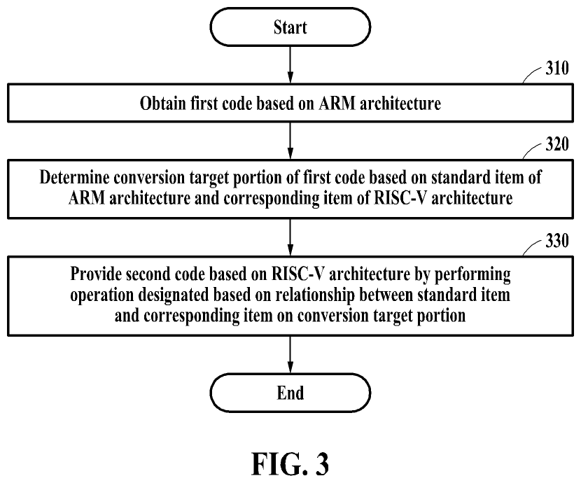

A computing device 220 may include a memory 221, a processor 222, and a display 223. The computing device 220 may provide second code generated from first code by performing a code conversion method. The code conversion method is described below with reference to FIG. 3.

The memory 221 may store data. For example, the memory 221 may store instructions for the code conversion method. The memory 221 may also store data (e.g., mapping information) used in the code conversion methods. The processor 222 may execute the instructions and process the data. For example, the processor 222 may provide the second code from the first code by performing the code conversion method, specifically, by performing an operation (e.g., a code substitution operation, a code modification operation, and/or a presentation operation of implementation guide information) designated based on the mapping information (e.g., a conversion level).

The display 223 may present information visually. For example, the display 223 may include a device that presents information visually, such as a liquid crystal display (LCD) and a light emitting diode (LED). The display 223 may present progress information described below.

FIG. 3 illustrates an example of a code conversion method, according to one or more embodiments.

In operation 310, an electronic device (e.g., a computing device) may obtain first code in a first ISA configured to execute on a first architecture (e.g., the ARM architecture). For example, the electronic device may receive the first code from a user. The electronic device may also receive the first code transmitted from another electronic device (e.g., a server). In addition, the electronic device may load the first code from a memory.

In operation 320, the electronic device may determine a conversion target portion of the first code, based on a standard item of the first architecture and a corresponding mapped-to item of a second architecture (e.g., a RISC-V architecture). For example, the electronic device may obtain parsed code, in which the first code is converted into a structured form, by parsing the first code. For example, the parsed code may be any intermediary representation of the first code, which is generally a language- and machine-independent representation of source code. Such an intermediate representation may include Abstract Syntax Trees (ASTs), Three-Address Code (TAC), Continuation-Passing Style (CPS), LLVM Intermediate Representation, or the like. Thereafter, the electronic device may determine, from among syntax elements included in the parsed code, a syntax element corresponding to the standard item based on the first architecture to be the conversion target portion.

In operation 330, the electronic device may provide second code of the second architecture by performing an operation, which has been designated based on a relationship between the standard item and the corresponding item of the mapping information, on the conversion target portion. For example, the electronic device may perform an operation according to the conversion level designated to the relationship between the corresponding item and the standard item corresponding to the syntax element of the conversion target portion. The conversion level may indicate an operation for a conversion from the standard item to the corresponding item. For example, a different specific operation may be designated to each conversion level according to a degree of high or low of the conversion level. For example, when the conversion level is within a first level range (e.g., level 1 and level 2), a code substitution operation may be designated to that conversion level. When the conversion level is within a second level range, a code modification operation of the conversion target portion may be designated to that conversion level. The second level range may be a higher level range (e.g., level 3 to level 7) than the first level range. When the conversion level is within a third level range, a presentation operation of presenting an implementation guide (implementation information) for implementing the conversion target portion may be designated to that conversion level. The third level range may be a higher level range (e.g., level 8 and level 9) than the second level range. In addition, even within a same level range, a more difficult detailed operation may be designated to a higher conversion level. For example, when a level 1 and a level 2 are within the first level range, an operation of substituting a syntax element of the conversion target portion with a corresponding element at a location of that syntax element may be designated to the level 1. On the other hand, an operation of substituting the syntax element of the conversion target portion with the corresponding element and subsequently inserting the corresponding element at a different location from the location of that syntax element may be designated to the level 2.

FIG. 4 illustrates an example of a code conversion platform, according to one or more embodiments.

A code conversion platform 400 may include mapping information 401, a conversion target setting module 402, a version selection module 403, a mapping information management module 404, a conversion module 405, a dashboard module 406, a storage management module 407, a build verification module 408, and a deployment environment validation module 409. The electronic device may manage the mapping information 401 through the mapping information management module 404. The electronic device may provide second code based on a second architecture (e.g., RISC-V architecture) from first code based on a first architecture (e.g., ARM architecture) through the modules 401 to 403, and 405 to 407. In addition, the electronic device may verify the second code provided via the modules 408 and 409. The modules 401 to 409 may form the single code conversion platform 400 that provides the second architecture based software code converted from the first architecture based software code, verifies the provided second architecture based software code, and is updated as needed.

The mapping information 401 may indicate relationships between standard items of the first architecture and corresponding items of the second architecture and may include a mapping between two items and a conversion level for the two mapped items. In addition, the mapping information 401 may include the first architecture (e.g., ARM architecture) version that may support the standard item and the second architecture (e.g., RISC-V architecture) version that may support the corresponding item. The electronic device may, by performing the operations of the code conversion method based on the same mapping information 401, improve consistency and readability of the converted code (e.g., second code) compared to a case in which multiple developers manually perform code conversion.

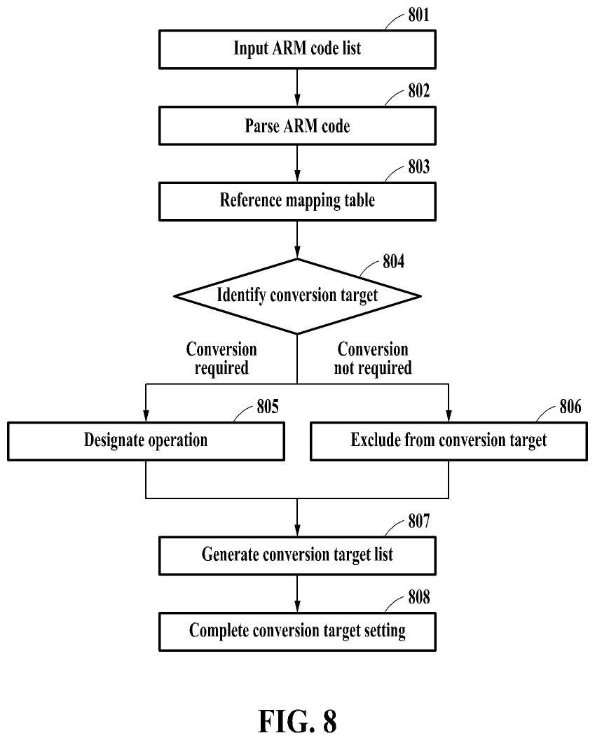

The conversion target setting module (402) may be configured for selecting a conversion target portion from among the syntax elements included in the first code. The electronic device may parse the first code through the conversion target setting module 402 and determine the conversion target portion. A conversion target setting operation through the conversion target setting module 402 is described below with reference to FIG. 8.

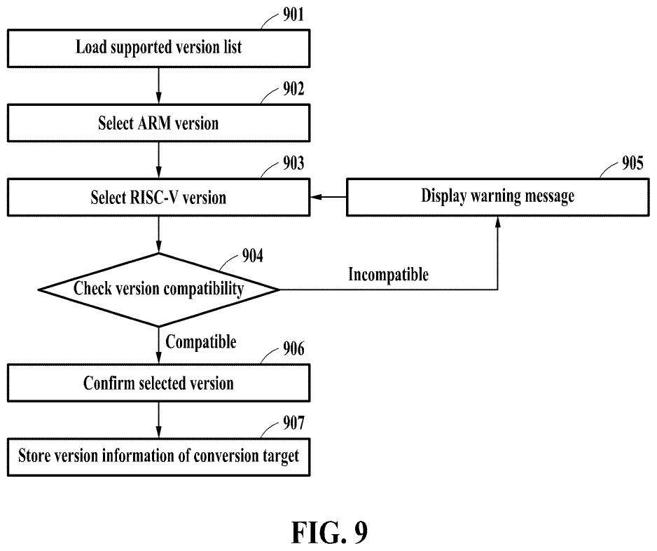

The version selection module 403 may be configured for selecting the first architecture version (e.g., an ARM architecture version) and a specific RISC-V version that may support the determined conversion target portion. A version selection operation according to the version selection module 403 is described below with reference to FIG. 9.

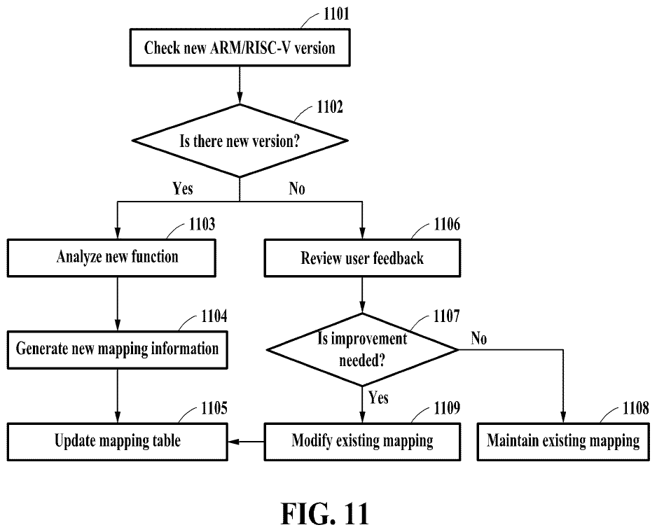

The mapping information management module 404 may be configured for updating the mapping information 401 when the first architecture version or the second architecture version, different from an existing one, exists or is needed. Management operations using the mapping information management module 404 are described below with reference to FIG. 11.

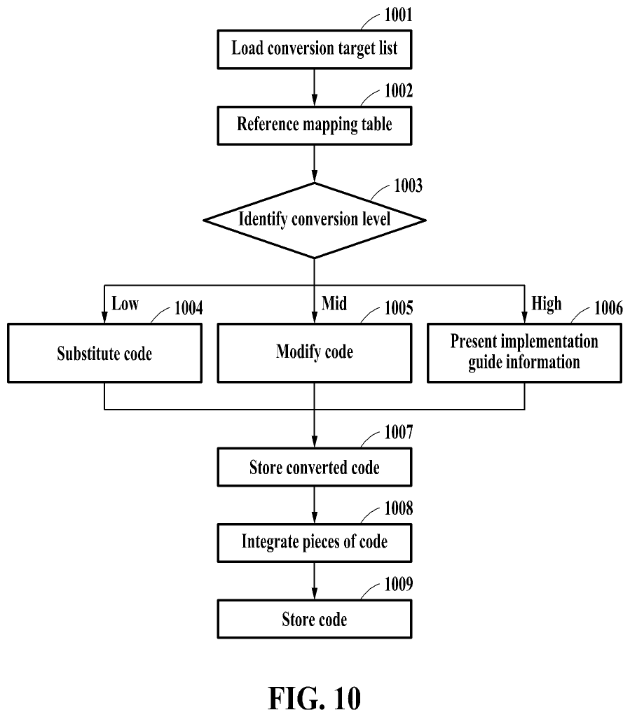

The conversion module 405 may be configured for providing the second code by performing a designated operation on the conversion target portion. For example, the electronic device may perform an operation designated based on the relationship (e.g., a conversion level) between the standard item and the corresponding item of the mapping information 401. A conversion operation using the conversion module 405 is described below with reference to FIG. 10.

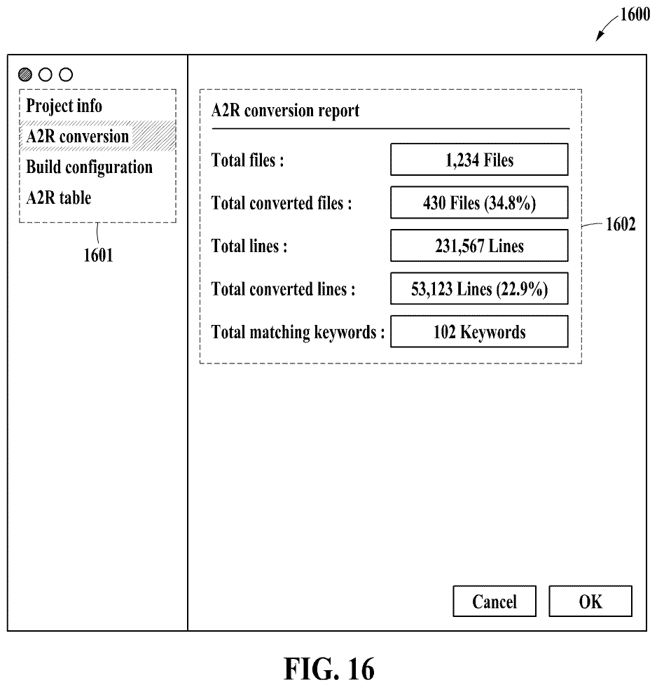

The dashboard module 406 may be a module for displaying indicators of a conversion process and result, for example in the form of a user interface (e.g., graphics, renderable code, etc.). For example, the electronic device may present progress information through a display. The progress information may include a conversion rate corresponding to converted syntax elements relative to the conversion target portion. The dashboard module 406 is described below with reference to FIG. 16.

The storage management module 407 may be configured for storing the converted syntax elements. For example, the electronic device may store the second code including the converted syntax elements in a memory via the storage management module 407.

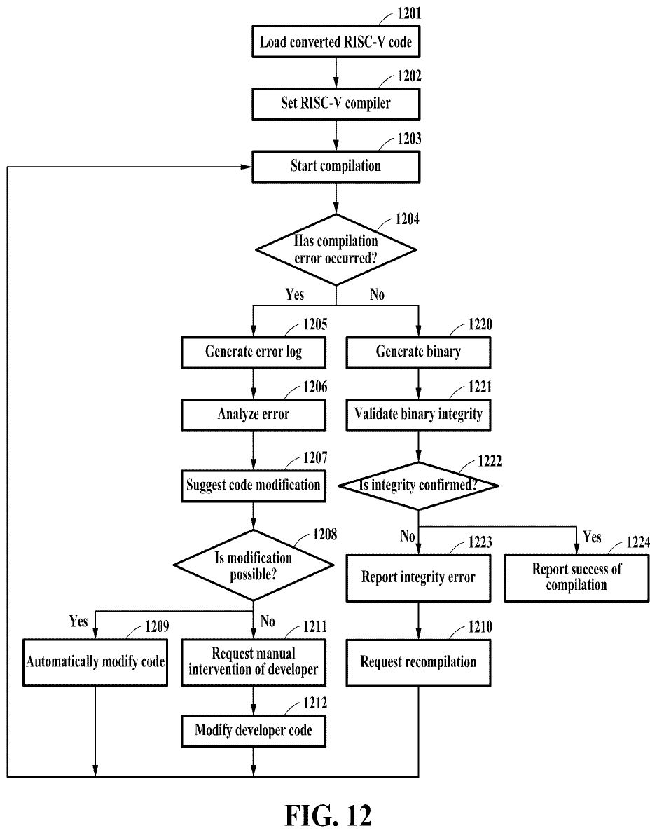

The build verification module 408 may be configured for building (e.g., compilation) the second code and verifying whether there is an error. For example, the electronic device may compile the second code into binary code by using a compiler (e.g., a RISC-V compiler) via the build verification module 408. In addition, the electronic device may automatically modify the code or verify an integrity of the code based on a whether the compilation is successful. A build verification operation according to the build verification module 408 is described below with reference to FIG. 12.

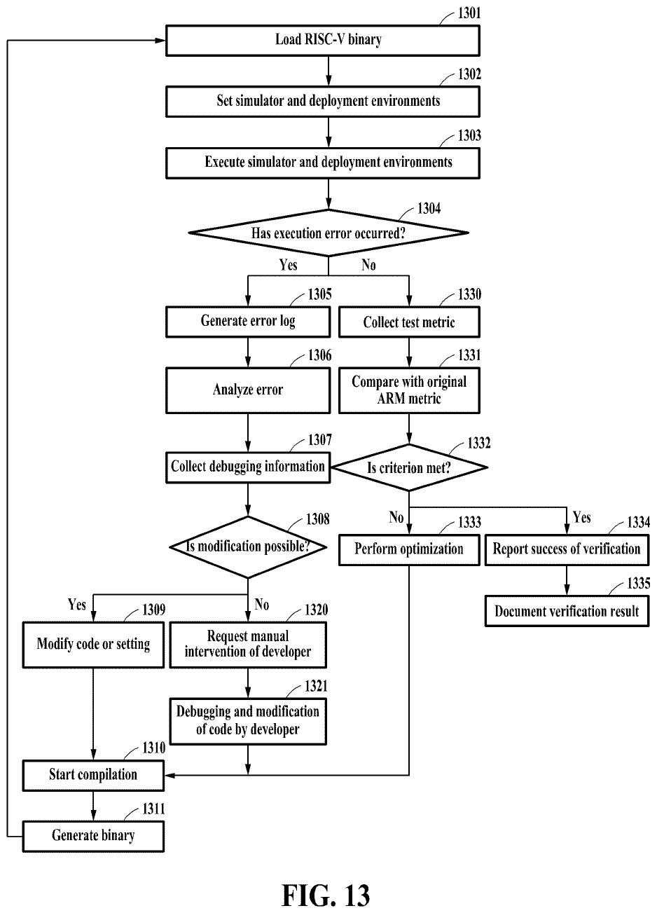

The deployment environment validation module 409 may be configured for validating the binary code, which may be obtained by compiling the second code, by executing the binary code in a simulator environment of the second architecture (e.g., a RISC-V simulator environment) or a deployment environment of the second architecture (e.g., a RISC-V deployment environment). For example, the electronic device may obtain validation information on the binary code based on a result of executing the binary code in the simulator environment of the second architecture or a hardware environment of the second architecture through the deployment environment validation module 409. A deployment environment validation operation according to the deployment environment validation module 409 is described below with reference to FIG. 13.

The electronic device may significantly the time and manpower required for code conversion by automating the conversion from the first architecture based code to the second architecture based code through the code conversion platform 400, thereby allowing developers to focus on more creative and valuable work.

Although operations of the modules 401 to 409 of FIG. 4 have been described herein, the modules 401 to 409 are only examples to help understanding, and the configuration of the present disclosure is not limited thereto. The operations of the modules 401 to 409 described above may be performed by a processor of the electronic device.

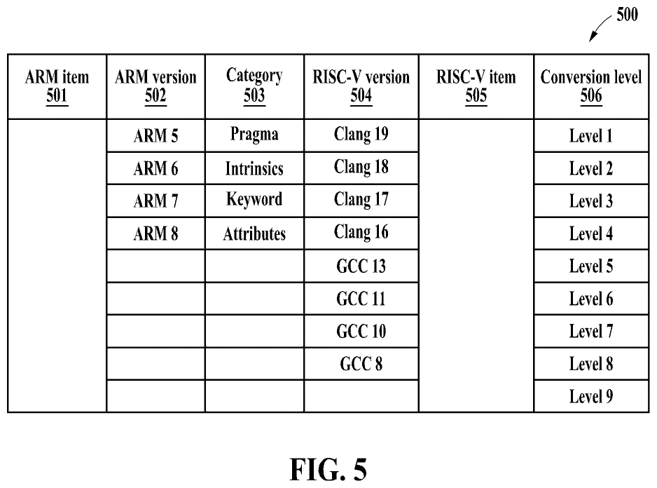

FIG. 5 illustrates an example of mapping information, according to one or more embodiments.

Mapping information 500 may have a mapping table format as shown in FIG. 5. The mapping information 500 may include a standard item 501 of a first architecture (e.g., ARM architecture), an ARM version 502, a language extension 503 of the first architecture (e.g., ARM architecture), a RISC-V version 504, a corresponding item 505 of a second architecture (e.g., RISC-V architecture), and a conversion level 506.

The standard item 501 may be an item corresponding to a standard syntax element of the first architecture. For example, the standard item 501 may include an item corresponding to the language extension 503 of the first architecture.

The ARM version 502 may include a version of the first architecture that may be supported according to the mapping information 500. For example, the ARM version 502 may include ARM 5, ARM 6, ARM 7, and/or ARM 8.

The language extensions 503 may include instruction sets or features specific to the first architecture. For example, the language extension 503 may include at least one of a compiler pragma, which is a preprocessor directive (which instructs the compiler), intrinsics (which are built-in functions that provide direct access to processor functionality), a keyword (which is a word unique to the compiler of the first architecture), and directive attributes (which indicate additional information on functions), variables, types, and/or the like.

The RISC-V version 504 may include a version of the second architecture (e.g., RISC-V architecture) that may be supported according to the mapping information 500. For example, the RISC-V version 504 may include at least one of Clang 19, Clang 18, Clang 17, Clang 16, GCC 13, GCC 11, GCC 10, or GCC 8.

The corresponding item 505 may include an item corresponding to a syntax element of the second architecture corresponding to the standard item 501. The corresponding item 505 may be classified into a substitution item of the standard item 501, a modification item of the standard item 501, and an implementation guide item for the standard item 501, according to the conversion level 506.

The conversion level 506 may represent an operation for conversion between the standard item 501 and the corresponding item 505. According to a high or low of the conversion level 506, an operation for a syntax element of the conversion target portion may be designated differently. For example, when the conversion level 506 is within a first level range (e.g., level 1 and level 2), the electronic device may perform a code substitution operation on the syntax element of the conversion target portion corresponding to the standard item 501. When the conversion level 506 is within a second level range (e.g., level 3 to level 7) that is higher than the first level range, the electronic device may perform a code modification operation on the syntax element of the conversion target portion corresponding to the standard item 501. When the conversion level 506 within a third level range (e.g., level 8 and level 9) higher than the second level range, the electronic device may perform a presentation operation of an implementation guide for the syntax element of the conversion target portion corresponding to the standard item 501.

A code substitution operation may include an operation of substituting a syntax element corresponding to the standard item 501 of the first architecture with a corresponding element based on the second architecture according to the corresponding item 505. The code modification operation may include changing all or part of a syntax element corresponding to the standard item 501 or adding other code. The presentation operation of an implementation guide may include an operation of displaying implementation guide information about conversion from a syntax element corresponding to the standard item 501 of the first architecture to code based on the second architecture. The conversion of the first code according to the performance of each operation is described below with reference to FIGS. 7 and 10.

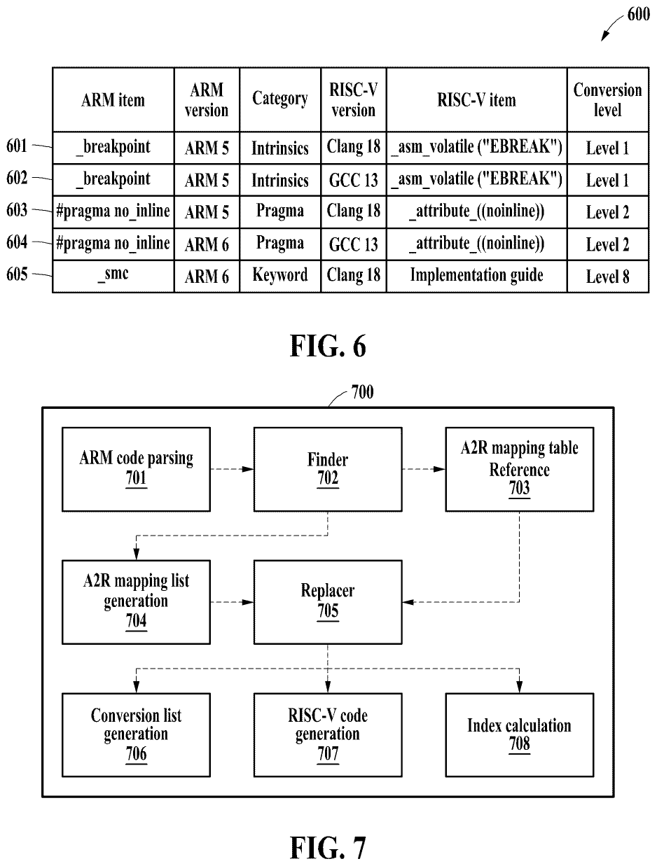

FIG. 6 illustrates an example of mapping information, according to one or more embodiments.

Mapping information 600 may be a mapping table including rows 601 to 605.

As shown in row 601 of FIG. 6, a conversion level between a standard item (e.g., _breakpoint) and a corresponding item (e.g., _asm_volatile (“EBREAK”)) may be associated with level 1. In addition, the standard item (e.g. _breakpoint) may correspond to intrinsics among language extensions. Here, an ARM version corresponding to the standard item (e.g. _breakpoint) may be ARM 5, and a RISC-V version of the corresponding item (e.g. _asm_volatile (“EBREAK”)) may be Clang 18. As shown in the row 602, the RISC-V version corresponding to the corresponding item (e.g., _asm_volatile (“EBREAK”)) may be GCC 13. For example, the electronic device may substitute a syntax element (e.g., _breakpoint) included in a conversion target portion according to the row 601 or the row 602 with a corresponding element (e.g., _asm_volatile (“EBREAK”)).

As shown in row 603, the conversion level between the standard item (e.g., #pragma no_inline) and the corresponding item (e.g., _attribute_((noinline))) may be level 2. In addition, the standard item (e.g. #pragma no_inline) may correspond to a compiler directive among the language extensions. Here, the ARM version corresponding to the standard item (e.g. #pragma no_inline) could be ARM 5, and the corresponding RISC-V version may be Clang 18. As shown in row 604, the RISC-V version corresponding to the corresponding item (e.g., _attribute_((noinline))) may be GCC 13. For example, the electronic device may substitute a syntax element (e.g., #pragma no_inline) included in the conversion target portion according to the row 603 or the row 604 with the corresponding element (e.g., _attribute_((noinline))).

As shown in the 605, the conversion level between the standard item (e.g., _smc) and the corresponding item (e.g., Implementation guide) may be level 8. In addition, the standard item (e.g., _smc) may correspond to a keyword among the language extensions. Here, the ARM version corresponding to the standard item (e.g. _smc) may be ARM 6, and the RISC-V version corresponding to the corresponding item (e.g. _attribute_((noinline))) may be Clang 18. For example, the electronic device may output information requesting example code similar to a syntax element (e.g., _smc) included in the conversion target portion according to the row 605.

FIG. 7 illustrates an example of a target setting and conversion module, according to one or more embodiments.

A target setting and conversion module 700 may include detailed modules 701 to 708.

An electronic device may obtain parsed code, in which first code (e.g., ARM architecture-based software code) is converted into a structured form, by parsing the first code through the module 701. The electronic device may determine through the module 702, from among syntax elements included in the parsed code, a syntax element corresponding to a standard item to be a conversion target portion. For example, the electronic device may identify the conversion target portion in a file or line level through the module 702. The electronic device may reference the mapping information via the module 703 at operations according to the modules 702 and 705. The electronic device may generate a list of syntax elements corresponding to the conversion target portion in an operation according to the module 704.

The electronic device may convert syntax elements within the conversion target portion into corresponding elements based on a second architecture (e.g., RISC-V architecture) via the module 705. Here, the conversion method for each syntax element may vary depending on a relationship (e.g., a conversion level) between the syntax elements and the corresponding elements specified in the mapping information. For example, when the conversion level is within a first level range (e.g., level 1 and level 2), the electronic device may substitute the syntax elements with the corresponding elements within the first level range. When the conversion level is within a second level range (e.g., level 3 to level 7), the electronic device may modify all or part of the syntax elements. The electronic device may present implementation guide information for syntax elements within the conversion target portion via the module 705 (e.g., in the form of comments). For example, when the conversion level is within a 3rd level range (e.g., level 8 and level 9), the electronic device may present the implementation guide information for the syntax elements. The second level range may be higher than the first level range. For example, the first level range may be level 1 and level 2, and the second level range may be level 3 to level 7. The third level range may be higher than the second level range. For example, the second level range may be level 3 to level 7, and the third level range may be level 8 and level 9. As can be seen, which elements are converted, and how they are converted, may depend on the conversion level.

The electronic device may, via the module 706, generate a list of syntax elements based on the first architecture and corresponding elements based on the second architecture. The electronic device may, via the module 707, generate second code based on the second architecture from converted syntax elements and other portions of the first code. The electronic device may, via the module 708, manage indicators measured or calculated in the code conversion operation and transmit the indicators to a dashboard module (e.g., the dashboard module 406 of FIG. 4). A conversion target portion setting operation and a code conversion operation performed according to the target setting and conversion module 700 are described below with reference to FIG. 8 and FIG. 10.

FIG. 8 illustrates an example of a conversion target portion setting operation, according to one or more embodiments.

An electronic device may perform a conversion target portion setting operation through a conversion target setting module.

In operation 801, the electronic device may receive first code based on a first architecture (e.g., ARM architecture). That is, the first code may be source code configured to be compiled for the first architecture/ISA. In operation 802, the electronic device may obtain parsed code by parsing the first code. In operation 803, the electronic device may determine whether a syntax element within the parsed code corresponds to a standard item of mapping information (i.e., whether the syntax element has a row in the mapping information). In operation 804, the electronic device may determine syntax elements that are determined to correspond to the standard item of the mapping information as a portion requiring conversion (e.g., a conversion target portion).

In operation 805, the electronic device may designate an operation for the portion based on the existence of a relationship between a corresponding item and the standard item of the conversion target portion. For example, the electronic device may designate a code substitution operation, a code modification operation, and/or a presentation operation of implementation guide information for a syntax element, depending on the conversion level between the standard item corresponding to the syntax element of the conversion target portion and the corresponding item.

In operation 806, the electronic device may exclude, from a conversion target, a portion within the parsed code that is not determined as the conversion target portion. That is, a portion of the parsed code may be determined to not be a target for conversion. In operation 807, the electronic device may generate a conversion target list. The conversion target list may include syntax elements corresponding to the conversion target portion. In operation 808, the electronic device may display information indicating that the conversion target setting is complete.

FIG. 9 illustrates an example of a version selection operation, according to one or more embodiments.

An electronic device may support various versions of a first architecture (e.g., ARM architecture) and a second architecture (e.g., RISC-V architecture) so that a user may perform optimal conversions that meet specific hardware or software requirements. Hereafter, a version selection operation in which a user selects versions of the first architecture and the second architecture is described.

The electronic device may perform the version selection operation via a version selection module.

In operation 901, the electronic device may select a first architecture (e.g., ARM architecture) version and a second architecture (e.g., RISC-V architecture) version supported according to the mapping information (or according to a supported version list).

In operation 902, the electronic device may select the first architecture version, for example, by receiving a user input selecting the first architecture version.

In operation 903, the electronic device may select the second architecture version, for example, by receiving a user input selecting the second architecture version.

In operation 904, the electronic device may check for version compatibility. For example, the electronic device may determine that the two versions are compatible based on the existence of mapping information (e.g., a mapping table) between the selected first architecture version and the selected second architecture version. On the contrary, the electronic device may determine that the two versions are incompatible based on the absence of mapping information (e.g., a mapping table) between the selected first architecture version and the selected second architecture version.

In operation 905, the electronic device may display a warning message (e.g., via a display) in response to the determination of incompatibility. Thereafter, the electronic device may receive from the user a selection of the second architecture version again in operation 903.

In operation 906, the electronic device may confirm the selected first architecture version and the selected second architecture version, in response to the first architecture version and the second architecture version being determined to be compatible.

In operation 907, the electronic device may store information on the confirmed first architecture version and the confirmed second architecture version for use in conversion.

FIG. 10 illustrates an example of a conversion operation, according to one or more embodiments.

An electronic device may perform the conversion operation through a conversion module.

In operation 1001, the electronic device may load a conversion target list.

In operation 1002, the electronic device may identify items corresponding to syntax elements (in the conversion target list) by referencing mapping information.

In operation 1003, the electronic device may identify a conversion level to be used for converting each of the syntax elements in the conversion target list. The electronic device may perform one of operations 1004 to 1006 depending on a degree of the conversion level.

In operation 1004, the electronic device may perform a code substitution operation based on the conversion level being within a first level range (e.g., level 1 and level 2). For example, in response to a first substitution level (e.g., level 1) being designated to a relationship between a standard item in the mapping information (that standard item corresponding to a syntax element of a conversion target portion), and a corresponding item, the electronic device may perform a first substitution operation, which simply replaces the corresponding syntax element with a second architecture based syntax element according to a corresponding item at a same location. In addition, based on a second substitution level (e.g., level 2) being designated to the relationship between a standard item (which corresponds to a syntax element of the conversion target portion) and a corresponding item, the electronic device may perform a second substitution operation, which inserts a second architecture-based corresponding element substituted from a corresponding syntax element at a different location in first code from a location of the conversion target portion. The second substitution level may be higher than the first substitution level.

In operation 1005, the electronic device may perform a code modification operation based on the conversion level being the second conversion level. For example, the electronic device may perform a first modification operation that adds another/new code to a corresponding syntax element based on a first modification level (e.g., level 3) being designated to the relationship between a standard item (which corresponds to a syntax element of the conversion target portion) and a corresponding item. In addition, the electronic device may perform a second modification operation that changes part of a syntax of a corresponding syntax element based on a second modification level (e.g., level 4) being designated to the relationship between a standard item (which corresponds to a syntax element of the conversion target portion) and a corresponding item. The electronic device may also perform a third modification operation that changes an entire syntax of a corresponding syntax element based on a third modification level (e.g., level 5) being designated to the relationship between a standard item (which corresponds to a syntax element of the conversion target portion) and a corresponding item. The electronic device may also perform a fourth modification operation that adds code according to an additional logic to the first code based on a fourth modification level (e.g., level 6) being designated to the relationship between a standard item (which corresponds to a syntax element of the conversion target portion) and a corresponding item. The electronic device may also perform a fifth modification operation that replaces a syntax element with code according to an additional logic based on a fifth modification level (e.g., level 7) being designated to the relationship between a standard item (which corresponds to a syntax element of the conversion target portion) and a corresponding item.

In operation 1006, the electronic device may perform a presentation operation of implementation guide information based on the conversion level being a third conversion level. The operation of presenting implementation guide information may be an operation of outputting implementation guide information from a syntax element based on the first architecture to code based on the second architecture. For example, based on a first presentation level (e.g., level 8) being designated to the relationship between the corresponding item and the standard item (in the mapping information) corresponding to a syntax element of the conversion target portion, the electronic device may perform a first presentation operation of outputting information requesting example code similar to the corresponding syntax element. In addition, based on a second presentation level (e.g., level 9) being designated to the relationship between the corresponding item and the standard item (in the mapping information) corresponding to a syntax element of the conversion target portion, the electronic device may perform a second presentation operation of outputting information requesting an implementation concept for the corresponding syntax element. The second presentation level may be higher than the first presentation level. The electronic device may receive code, in which a syntax element of the conversion target portion has been converted by a user using the implementation guide information.

In operation 1007, the electronic device may store the code obtained through operations 1004 to 1006. In operation 1008, the electronic device may integrate thus-obtained pieces of code. For example, the electronic device may obtain the second code by integrating the syntax elements converted through operations 1004 and 1005, the syntax elements received through operation 1006, and other portions of the first code (e.g., portions other than the conversion target portion of the first code). In operation 1009, the electronic device may store the second code for later compiling, editing, etc.

FIG. 11 illustrates an example of a mapping information management operation, according to one or more embodiments.

An electronic device may perform a mapping information management operation.

In operation 1101, the electronic device may receive information on a new architecture version (e.g., a newly released first architecture version or a newly released second architecture version) from a user.

In operation 1102, the electronic device may determine whether a new architecture version exists in mapping information, based on the information on the received new architecture version. The electronic device may display a result indicating whether a new architecture version exists in the mapping information.

In operation 1103, the electronic device may obtain an analysis result (e.g., information representing a result of an analysis on a new architecture version) by analyzing a function of the new architecture version (e.g., extracting, from the new architecture version, a function that does not exist in the architecture version (e.g., ARM version or RISC-V version) included in the existing mapping information). In addition, the electronic device may receive an analysis result from the user.

In operation 1104, the electronic device may generate new mapping information based on the analysis result. The new mapping information may be generated by adding, to existing mapping information, information corresponding to the function that does not exist in any architecture version included in the existing mapping information. The electronic device may also receive new mapping information from the user.

In operation 1105, the electronic device may generate new mapping information or receive new mapping information from a user when a new architecture version (e.g., a newly released first architecture version or a newly released second architecture version) exists in the existing mapping information. In addition, the electronic device may receive modified mapping information that reflects improvement requirements from a user for an existing architecture version, when a new architecture version does not exist in the existing mapping information. The electronic device may update (e.g., modify) the mapping information to the new or modified mapping information received.

In operation 1106, when the new architecture version does not exist in the mapping information, the electronic device may display user feedback. For example, the user feedback may provide information representing an evaluation of the user of a code conversion platform based on the existing mapping information. The electronic device may receive a review result of the user feedback from the user.

In operation 1107, the electronic device may determine whether improvement of the mapping information is needed. For example, the electronic device may receive information from the user indicating whether the mapping information needs to be improved.

In operation 1108, in response to determining that improvement of the mapping information is not necessary, the electronic device may display information indicating that the existing mapping information is maintained as is.

In operation 1109, in response to determining that improvement of the mapping information is necessary, the electronic device may modify the existing mapping information. For example, the electronic device may receive modified mapping information from the user. As described above, the electronic device may update the mapping information to the modified mapping information in operation 1105.

The electronic device may continuously reflect new architecture versions or user feedback through the mapping information management operation and may thus gradually improve the performance and accuracy of the code conversion platform over time.

FIG. 12 illustrates an example of a build verification operation, according to one or more embodiments.

An electronic device may perform a build verification operation via a build verification module.

In operation 1201, the electronic device may load second code converted from first code. In operation 1202, the electronic device may receive, from the user, a selection of a compiler (e.g., a RISC-V compiler) suitable for the second code and settings of necessary compiler options. In operation 1203, the electronic device may initiate compilation of the second code (depending on context, “compile” may mean attempt to compile, depending on context).

In operation 1204, the electronic device may determine whether an error has occurred during a compilation process. When an error occurs during the compilation process, the electronic device may display information indicating the occurrence of an error.

In operation 1205, in response to the error occurring during the compilation process, the electronic device may record detailed information of the error in a log file.

In operations 1206 and 1207, the electronic device may analyze a cause of the error and present (e.g., display) a proposed modification to code (e.g., a modification to the second code to resolve the error or a request for developer intervention). For example, an electronic device may present a proposed code modification method based on an automatic modification manual, which may include information indicating code modifications for respective specific errors. When the code modification method for an error is included in the automatic modification manual, the electronic device may present a code modification method according to the automatic modification manual. On the contrary, when a modification method for an error that has occurred is not included in the automatic modification manual, the electronic device may present the request for developer intervention.

In operation 1208, the electronic device may determine whether automatic modification of the second code is possible. For example, the electronic device may determine that automatic modification of the second code is possible in response to a code modification method being presented in the code correction method. The electronic device may determine that automatic modification of the second code is not possible in response to a developer intervention request being presented in the code modification method.

When it is determined that automatic modification of the second code is possible, the electronic device may automatically modify the second code according to the presented code modification method in operation 1209. Thereafter, the electronic device may again compile the modified second code through operation 1203.

When it is determined that automatic modification of the second code is not possible, the electronic device may request a manual intervention of a developer in operation 1211. For example, an electronic device may output information that requests a manual intervention of a developer.

In operation 1212, the electronic device may receive modified second code in response to a request for manual intervention of developer. Thereafter, the electronic device may compile the modified second code through operation 1203.

In operation 1220, the electronic device may generate binary code by compiling the second code. In operation 1221, the electronic device may verify an integrity of the generated binary code (e.g., verification by checksum).

In operation 1222, the electronic device may determine whether there is an integrity error in the binary code. For example, the electronic device may determine whether there is an integrity error in the binary code based on an integrity verification result according to the checksum method.

In operation 1223, the electronic device may report an integrity error (e.g., output information indicating an integrity error) in response to a presence of an integrity error in the binary code.

In operation 1210, the electronic device may request recompilation of the second code (e.g., output information requesting recompilation of the second code). Subsequently, the electronic device may start compilation of the second code again in operation 1203.

At step (1224), the electronic device may report success of the compilation (e.g., output information indicating success of the compilation) in response to the absence of integrity errors in the binary code.

FIG. 13 illustrates an example of a deployment environment verification operation, according to one or more embodiments.

The electronic device may perform a deployment environment verification operation through a deployment environment verification module.

In operation 1301, the electronic device may load binary code obtained by compiling the second code. In operation 1302, the electronic device may receive environment settings by the user so that binary code may be executed in a simulator of the second architecture or in a second architecture-based hardware environment (i.e., a hardware environment of the second architecture). In operation 1303, the electronic device may execute the binary code in the simulator of the second architecture or in the real hardware environment of the second architecture. In operation 1304, the electronic device may determine whether an error occurred during execution. For example, the electronic device may determine that no error has occurred during execution, in response to the binary code successfully executing in the simulator of the second architecture or in the real second architecture-based hardware environment. On the contrary, the electronic device may determine that an error has occurred during execution, in response to a failure to successfully execute the binary code in the simulator of the second architecture or in the real second architecture-based hardware environment.

In response to an error occurring during execution, the electronic device may generate an error log by recording detailed information of the error in operation 1305. In operation 1306, the electronic device may analyze a cause and an occurrence point of the error based on the generated error log. In operation 1307, the electronic device may collect additional debugging information (e.g., a system of a timepoint of an error and a memory status). In operation 1308, the electronic device may determine whether the code may be modifiable based on an error log and additional debugging information. In operation 1309, the electronic device may modify the second code or the simulator/hardware environment settings in response to the code modification being determined to be possible.

In operations 1310 and 1311, the electronic device may generate binary code by compiling modified code. In operation 1320, the electronic device may request a manual intervention of a developer in response to the code modification being determined to be not possible. For example, an electronic device may output information that requests a manual intervention of a developer. In operation 1321, the electronic device may receive debugged and modified first code from the user. Thereafter, the electronic device may compile the debugged and modified first code in operation 1310. In operation 1330, the electronic device may collect test metrics. For example, the electronic device may collect execution time, memory usage, and CPU utilization.

In operation 1331, the electronic device may compare the collected test metrics with corresponding metrics of first architecture based first code to determine whether there is an improvement.

In operation 1332, the electronic device may determine whether a predetermined criterion is met based on a comparison result according to the metrics. For example, the predetermined criterion may be set to satisfy all of a reduction in execution time, a reduction in memory usage, and a reduction in CPU utilization.

In operation 1333, the electronic device may perform optimization in response to a predetermined criterion not being met. For example, the electronic device may perform optimization by modifying the second code or compiler settings (e.g., changing/setting a compiler parameter). Thereafter, the electronic device may compile the optimized second code in operation 1310.

In response to a predetermined criterion being met, the electronic device may report (e.g., output) a success of the verification and document a verification result in operations 1334 and 1335, respectively. For example, the electronic device may generate a file detailing an entire verification process, issues found, information on the metrics, and the like.

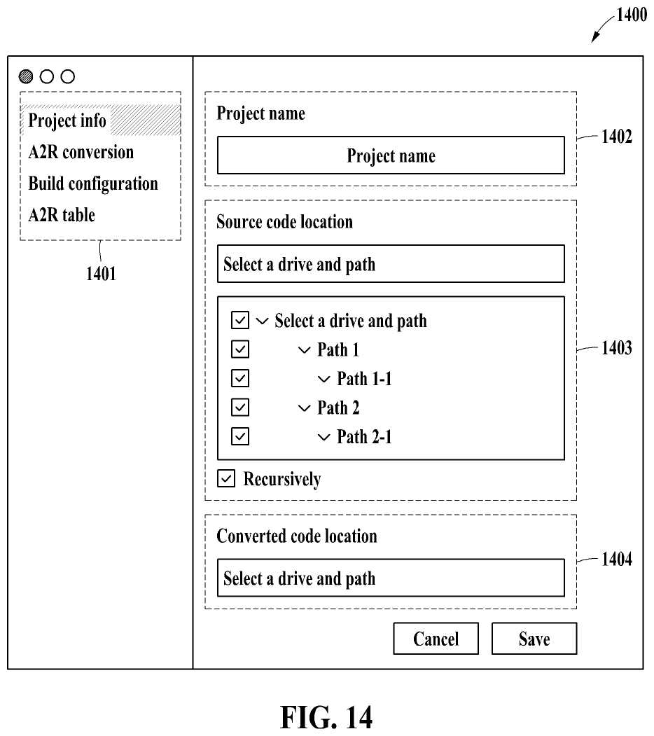

FIG. 14 illustrates an example of a user interface for setting a location of software code, according to one or more embodiments.

In a code conversion method, first code (based on a first architecture) to be converted may be distributed from a top location to various lower locations, so a user interface 1400 capable of efficiently supporting setting a location of the first code may be required.

A user interface 1400 may include portions 1401 to 1404. A project information tab in the portion 1401 may correspond to the user interface 1400 for setting locations of software code. In the portion 1402, the electronic device may receive a name of a project from a user. In the portion 1403, the electronic device may receive, by the user, a location of first code to be retrieved. The location of the first code that has been received may be stored in extensible markup language (XML) or database (DB) formats and may be referenced by function modules used in a subsequent code conversion method. In the portion 1404, the electronic device may receive a storage location of second code generated by the user.

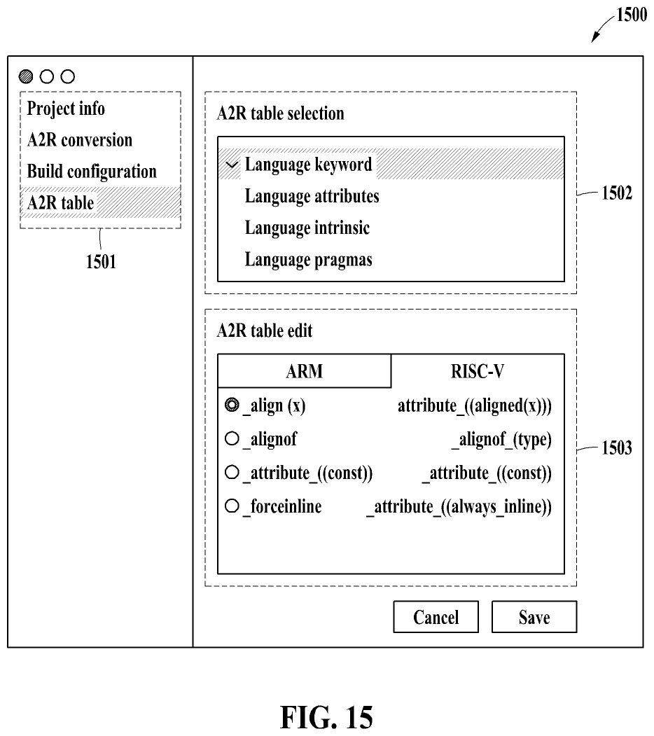

FIG. 15 illustrates an example of a user interface for managing mapping information, according to one or more embodiments.

An electronic device may manage mapping information through a mapping information management module by using a user interface 1500. A mapping information tab (e.g., A2r table) of a portion 1501 may be a tab corresponding to the user interface 1500 for managing the mapping information. A portion 1502 may be an interface through which a category (e.g., a language extension of a first architecture) of the mapping information may be selected. For example, the electronic device may receive, from a user, a selection from among Language keyword, Language attributes, Language intrinsic, and Language pragmas in the portion 1502. A portion 1503 may display standard items of the first architecture (e.g., ARM architecture) corresponding to the category selected in the portion 1502 and corresponding items based on a second architecture (e.g., RISC-V architecture). The electronic device may update the mapping information by modifying the standard items and corresponding items based on information received from the user through the portion 1503.

FIG. 16 illustrates an example of a user interface displaying progress information, according to one or more embodiments.

An electronic device may display progress information via a dashboard module by using a user interface 1600. A tab (e.g., A2R conversion) representing code conversion in a portion 1601 may be a tab corresponding to the user interface 1600 displaying progress information. In a portion 1602, the electronic device may present progress information. The progress information may be information indicating a progress of code conversion. For example, the progress information may include a conversion rate corresponding to converted syntax elements relative to the conversion target portion. The progress information may be displayed as shown in Table 1 below.

TABLE 1

| No | Item | Definition | Output formula | Example | Remarks |
|---|---|---|---|---|---|
| 1 | Total files | Total number of | | 5,000 files | |
| | | files analyzed for | | | |
| | | A2R conversion | | | |
| 2 | Total Code | Total number of | | 500,000 code | |
| | Lines | code lines | | lines | |
| | | analyzed for A2R | | | |
| | | conversion | | | |
| 3 | Total | Number of | | 150 pieces | |
| | Language | standard | | | |
| | Extensions | language | | | |
| | | extensions items | | | |
| | | for A2R | | | |
| | | conversion | | | |
| 4 | Files Found | Number of files | | 50 files | |
| | | detected as | | | |
| | | including | | | |
| | | language | | | |
| | | extensions items | | | |
| 5 | Code Lines | Number of code | | 50,000 code | |
| | Found | lines detected as | | lines | |
| | | including | | | |
| | | language | | | |
| | | extensions items | | | |
| 6 | Language | Number of | | 60 pieces | |
| | Extensions | language | | | |
| | Found | extensions items | | | |
| | | detected | | | |
| | | according to the | | | |
| | | analysis results | | | |
| 7 | Ratio of Files | Percentage of | (Files found)/ | 1% | Detection rate |
| | Found over | files including | (Total files) * | | (Target SW |
| | Total Files (%) | language | 100 (%) | | attribute) |
| | | extensions items | | | |
| | | among all files | | | |
| | | (%) | | | |
| 8 | Ratio of Code | Percentage of | (Code lines | 10% | Detection rate |
| | Lines over | code lines that | found)/(Total | | (Target SW |
| | Total Code | include language | code lines) * 100 | | attribute) |
| | Lines (%) | extensions | (%) | | |
| | | among all code | | | |
| | | lines (%) | | | |
| 9 | Ratio of | Percentage of | (Language | 20% | Detection rate |
| | Language | detected | extensions | | (Target SW |
| | Extensions | language | found)/(Total | | attribute) |
| | Found over | extensions items | language | | |
| | Total | among all | extensions) * | | |
| | Language | language | 100 (%) | | |
| | Extensions (%) | extensions items | | | |
| | | (%) | | | |
| 10 | Files | Number of files | | 40 files | |
| | Converted | that completed | | | |
| | | A2R conversion | | | |
| 11 | Code Lines | Number of code | | 45,000 code | |
| | Converted | lines that | | lines | |
| | | completed A2R | | | |
| | | conversion | | | |
| 12 | Language | Number of | | 57 | |
| | Extensions | language | | | |
| | Converted | extensions items | | | |
| | | that completed | | | |
| | | A2R conversion | | | |
| 13 | Ratio of Files | The percentage | (Files converted)/ | 80% | Conversion rate |
| | Converted | of files that | (Files found) * | | (Tool |
| | over Files | completed A2R | 100 (%) | | performance) |
| | Found (%) | conversion | | | |
| | | among detected | | | |
| | | files (%) | | | |
| 14 | Ratio of Code | The percentage | (Code lines | 90% | Conversion rate |
| | Lines | of code lines that | converted)/ | | (Tool |
| | Converted | completed A2R | (Code lines | | performance) |
| | over Code | conversion | found) * | | |
| | Lines | among detected | 100 (%) | | |
| | Found(%) | code lines (%) | | | |
| 15 | Ratio of | The percentage | (Language | 95% | Conversion rate |
| | Language | of language | extensions | | (Tool |
| | Extensions | extensions items | converted)/ | | performance) |
| | Converted | that completed | (Language | | |
| | over Language | A2R conversion | extensions | | |
| | Extensions | among detected | found) * | | |
| | Found (%) | language | 100 (%) | | |
| | | extensions items | | | |
| | | (%) | | | |

Items corresponding to No. 13 to No. 15 in Table 1 may correspond to the conversion rate, that is, a ratio of converted syntax elements relative to the conversion target portion. In Table 1, language extension may indicate a language extension, and files or code lines including language extension items may indicate the conversion target portion. The detection rate may represent a rate corresponding to the conversion target portion within the first code relative to the first code. The electronic device may present progress information including at least one of the items in Table 1 above via a display.

The electronic device may present progress information through a display, allowing the user to monitor a conversion process and result in real time, thereby allowing the user to easily understand the progress and performance of a conversion task.

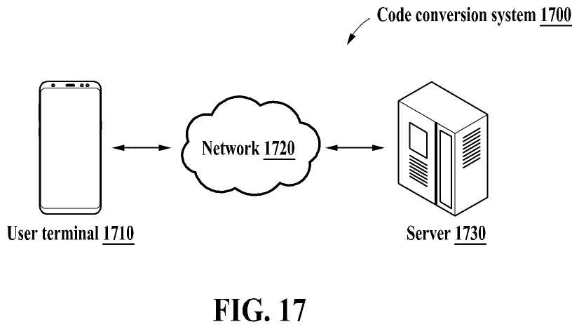

FIG. 17 illustrates an example of a code conversion system, according to one or more embodiments.

A code conversion system 1700 may perform the code conversion methods described above. The code conversion system 1700 may include a user terminal 1710 and a server 1730.

The user terminal 1710 may be an electronic device with which a user directly interacts and may be a computing device. The user terminal 1710 may be, for example, a desktop computer, a laptop computer, a mobile phone, a tablet personal computer (PC), or the like. The user terminal 1710 may communicate with the server 1730 via a network 1720. The network 1720 may include a communication device and a transmission line (e.g., an Internet line) used to interconnect remote devices (e.g., the user terminal 1710 and the server 1730) so that data may be exchanged between the remote devices. The server 1730 may be one or more computing devices that provide data to the user terminal 1710 via the network 1720.

The user terminal 1710 and the server 1730 of the code conversion system 1700 may cooperatively perform the code conversion methods. For example, some operations of the code conversion method may be performed by the user terminal 1710, and others may be performed by the server 1730. For example, the user terminal 1710 may receive first code from the user. The user terminal 1710 may transmit, via the network 1720, the first code to the server 1730 in which mapping information is stored. The server 1730 may determine a conversion target portion of the received first code based on a standard item and a corresponding item of the mapping information. In addition, the server 1730 may provide second code based on a second architecture (e.g., RISC-V architecture) by performing, on the conversion target portion, an operation designated based on a relationship (e.g., conversion difficulty) between a standard item and a corresponding item of the mapping information, the operation among a code substitution operation of the conversion target portion and a code modification operation of the conversion target portion. For example, the server 1730 may transmit the obtained second code to the user terminal 1710 via the network 1720. The user terminal 1710 may display the received second code. The user terminal 1710 may provide the second code based on the second architecture (e.g., RISC-V architecture) by performing, on the conversion target portion, a presentation operation of implementation guide information for the conversion target portion, the presentation operation designated based on the relationship between the standard item and the corresponding item of the mapping information. For example, the user terminal 1710 may display the implementation guide information for the conversion target portion and obtain the second code based on the code received from the user. The user terminal 1710 may present the obtained second code through a display. The user terminal 1710 may also present progress information during a conversion process. For example, while performing the code conversion method, the server 1730 may transmit progress information to the user terminal 1710 via the network 1720. The user terminal 1710 may present the received progress information.

A split execution of the code conversion method by the user terminal 1710 and the server 1730 has been described above, but the method of split execution is not limited thereto, and each operation of the code conversion method may be split and executed by the user terminal 1710 and the server 1730 in a different manner. For example, the user terminal 1710 or the server 1730 may individually perform all operations of the code conversion method.

The computing apparatuses, the electronic devices, the processors, the memories, the displays, the information output system and hardware, the storage devices, and other apparatuses, devices, units, modules, and components described herein with respect to FIGS. 1-17 are implemented by or representative of hardware components. Examples of hardware components that may be used to perform the operations described in this application where appropriate include controllers, sensors, generators, drivers, memories, comparators, arithmetic logic units, adders, subtractors, multipliers, dividers, integrators, and any other electronic components configured to perform the operations described in this application. In other examples, one or more of the hardware components that perform the operations described in this application are implemented by computing hardware, for example, by one or more processors or computers. A processor or computer may be implemented by one or more processing elements, such as an array of logic gates, a controller and an arithmetic logic unit, a digital signal processor, a microcomputer, a programmable logic controller, a field-programmable gate array, a programmable logic array, a microprocessor, or any other device or combination of devices that is configured to respond to and execute instructions in a defined manner to achieve a desired result. In one example, a processor or computer includes, or is connected to, one or more memories storing instructions or software that are executed by the processor or computer. Hardware components implemented by a processor or computer may execute instructions or software, such as an operating system (OS) and one or more software applications that run on the OS, to perform the operations described in this application. The hardware components may also access, manipulate, process, create, and store data in response to execution of the instructions or software. For simplicity, the singular term “processor” or “computer” may be used in the description of the examples described in this application, but in other examples multiple processors or computers may be used, or a processor or computer may include multiple processing elements, or multiple types of processing elements, or both. For example, a single hardware component or two or more hardware components may be implemented by a single processor, or two or more processors, or a processor and a controller. One or more hardware components may be implemented by one or more processors, or a processor and a controller, and one or more other hardware components may be implemented by one or more other processors, or another processor and another controller. One or more processors, or a processor and a controller, may implement a single hardware component, or two or more hardware components. A hardware component may have any one or more of different processing configurations, examples of which include a single processor, independent processors, parallel processors, single-instruction single-data (SISD) multiprocessing, single-instruction multiple-data (SIMD) multiprocessing, multiple-instruction single-data (MISD) multiprocessing, and multiple-instruction multiple-data (MIMD) multiprocessing.

The methods illustrated in FIGS. 1-17 that perform the operations described in this application are performed by computing hardware, for example, by one or more processors or computers, implemented as described above implementing instructions or software to perform the operations described in this application that are performed by the methods. For example, a single operation or two or more operations may be performed by a single processor, or two or more processors, or a processor and a controller. One or more operations may be performed by one or more processors, or a processor and a controller, and one or more other operations may be performed by one or more other processors, or another processor and another controller. One or more processors, or a processor and a controller, may perform a single operation, or two or more operations.

Instructions or software to control computing hardware, for example, one or more processors or computers, to implement the hardware components and perform the methods as described above may be written as computer programs, code segments, instructions or any combination thereof, for individually or collectively instructing or configuring the one or more processors or computers to operate as a machine or special-purpose computer to perform the operations that are performed by the hardware components and the methods as described above. In one example, the instructions or software include machine code that is directly executed by the one or more processors or computers, such as machine code produced by a compiler. In another example, the instructions or software includes higher-level code that is executed by the one or more processors or computer using an interpreter. The instructions or software may be written using any programming language based on the block diagrams and the flow charts illustrated in the drawings and the corresponding descriptions herein, which disclose algorithms for performing the operations that are performed by the hardware components and the methods as described above.

The instructions or software to control computing hardware, for example, one or more processors or computers, to implement the hardware components and perform the methods as described above, and any associated data, data files, and data structures, may be recorded, stored, or fixed in or on one or more non-transitory computer-readable storage media. Examples of a non-transitory computer-readable storage medium include read-only memory (ROM), random-access programmable read only memory (PROM), electrically erasable programmable read-only memory (EEPROM), random-access memory (RAM), dynamic random access memory (DRAM), static random access memory (SRAM), flash memory, non-volatile memory, CD-ROMs, CD-Rs, CD+Rs, CD-RWs, CD+RWs, DVD-ROM, DVD-Rs, DVD+Rs, DVD-RWs, DVD+RWs, DVD-RAMs, BD-ROMs, BD-Rs, BD-R LTHs, BD-REs, blue-ray or optical disk storage, hard disk drive (HDD), solid state drive (SSD), flash memory, a card type memory such as a multimedia card or a micro card (for example, secure digital (SD) or extreme digital (XD)), magnetic tapes, floppy disks, magneto-optical data storage devices, optical data storage devices, hard disks, solid-state disks, and any other device that is configured to store the instructions or software and any associated data, data files, and data structures in a non-transitory manner and provide the instructions or software and any associated data, data files, and data structures to one or more processors or computers so that the one or more processors or computers can execute the instructions. In one example, the instructions or software and any associated data, data files, and data structures are distributed over network-coupled computer systems so that the instructions and software and any associated data, data files, and data structures are stored, accessed, and executed in a distributed fashion by the one or more processors or computers.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, in addition to the above disclosure, the scope of the disclosure may also be defined by the claims and their equivalents, and all variations within the scope of the claims and their equivalents are to be construed as being included in the disclosure.

What is claimed is:

1. An electronic device comprising:
one or more processors; and
a memory storing instructions,
wherein the instructions, when executed by the one or more processors, cause the electronic device to:
obtain first code configured for an advanced reduced instruction set computer (RISC) machine (ARM) architecture;
determine a conversion target portion of the first code based on a standard item of the ARM architecture and a corresponding item of a RISC-V architecture; and
generate second code based on the RISC-V architecture by performing, on the conversion target portion, a conversion operation selected based on an association between the standard item and the corresponding item, wherein the conversion operation is a code substitution operation for at least a part of the conversion target portion, a code modification operation, or a presentation operation of including in the second code an implementation guide guiding conversion of the target portion.

2. The electronic device of claim 1, wherein the instructions, when executed by the one or more processors, cause the electronic device to:
obtain parsed code, in which the first code is converted into an intermediate representation, by parsing the first code; and
determine, from among syntax elements included in the parsed code, a syntax element corresponding to the standard item to be the conversion target portion.

3. The electronic device of claim 2, wherein the instructions, when executed by the one or more processors, cause the electronic device to:
when a first conversion level is designated to the association between the corresponding item and the standard item, which corresponds to the syntax element of the conversion target portion, perform the code substitution operation, which substitutes the syntax element with a RISC-V-based syntax element according to the corresponding item;
when a second conversion level is designated to the association between the corresponding item and the standard item, which corresponds to the syntax element of the conversion target portion, perform the code modification operation, which modifies the syntax element; and
when a third conversion level is designated to the association between the corresponding item and the standard item, which corresponds to the syntax element of the conversion target portion, perform the presentation operation wherein the implementation guide is directed to RISC-V-based code corresponding to the syntax element.

4. The electronic device of claim 1, wherein the code substitution operation comprises:
a first substitution operation, which substitutes a syntax element of the conversion target portion with a corresponding RISC-V-based element at a same code location as a code location of the conversion target portion; or
a second substitution operation, which substitutes the corresponding RISC-V-based element for the syntax element of the conversion target portion at a code location in the first code that is different from the code location of the conversion target portion.

5. The electronic device of claim 1, wherein the code modification operation comprises:
a first modification operation to add another code to a syntax element of the conversion target portion;
a second modification operation to change part of a syntax of a syntax element of the conversion target portion;
a third modification operation to change an entire syntax of a syntax element of the conversion target portion;
a fourth modification operation to add code according to an additional logic to the first code; or
a fifth modification operation to replace a syntax element of the first code with code according to an additional logic.

6. The electronic device of claim 1, wherein the presentation operation comprises:
a first presentation operation of outputting information comprising example code analogous to a syntax element of the conversion target portion; or
a second presentation operation of outputting information comprising an implementation concept for a syntax element of the conversion target portion.

7. The electronic device of claim 1, wherein the instructions, when executed by the one or more processors, cause the electronic device to:
generate the second code by integrating other portions of the first code with syntax elements that are converted by applying the code substitution operation or the code modification operation to the conversion target portion.

8. The electronic device of claim 1, further comprising:
a display,
wherein the instructions, when executed by the one or more processors, cause the electronic device to:
display, by the display, progress information indicating a conversion rate of conversion of syntax elements of the conversion target portion.

9. The electronic device of claim 1, wherein the instructions, when executed by the one or more processors, cause the electronic device to:
compile the second code into binary code by using a RISC-V compiler; and
obtain verification information on the binary code based on a result of execution of the binary code in a RISC-V simulator environment or a RISC-V hardware environment.

10. A computing system comprising:
a server configured to:
obtain first code configured for an advanced reduced instruction set computer (RISC) machine (ARM) architecture;
determine a conversion target portion of the first code, based on a standard item of the ARM architecture and a corresponding item of a RISC-V architecture; and
generate second code based on the RISC-V architecture by performing, on the conversion target portion, a conversion operation selected based on an association between the standard item and the corresponding item, wherein the conversion operation is either a code substitution operation for at least a part of the conversion target portion or is a code modification operation, and
a user terminal configured to generate the second code based on the RISC-V architecture by performing, on the conversion target portion, a presentation operation of including in the second code an implementation guide guiding conversion of the target portion, wherein the presentation operation is designated based on the relationship between the standard item and the corresponding item.

11. A code conversion method performed by one or more processors, the code conversion method comprising:
obtaining first code configured for an advanced reduced instruction set computer (RISC) machine (ARM) architecture;
determining a conversion target portion of the first code, based on a standard item of the ARM architecture and a corresponding item of a RISC-V architecture; and
generating second code based on the RISC-V architecture by performing, on the conversion target portion, a conversion operation selected based on an association between the standard item and the corresponding item, wherein the conversion operation is a code substitution operation for at least a part of the conversion target portion, a code modification operation, or a presentation operation of including in the second code an implementation guide guiding conversion of the target portion.

12. The code conversion method of claim 11, wherein the determining of the conversion target portion comprises:
obtaining parsed code, in which the first code is converted into an intermediate representation, by parsing the first code; and
determining, from among syntax elements included in the parsed code, a syntax element corresponding to the standard item to be the conversion target portion.

13. The code conversion method of claim 12, wherein the generating of the second code comprises:
when a first conversion level is designated to the relationship between the corresponding item and the standard item, which corresponds to the syntax element of the conversion target portion, performing the code substitution operation, which substitutes the syntax element with a RISC-V-based syntax element according to the corresponding item;
when a second conversion level is designated to the association between the corresponding item and the standard item, which corresponds to the syntax element of the conversion target portion, performing the code modification operation, which modifies the syntax element; and
when a third conversion level is designated to the association between the corresponding item and the standard item, which corresponds to the syntax element of the conversion target portion, perform the presentation operation wherein the implementation guide is directed to RISC-V-based code corresponding to the syntax element.

14. The code conversion method of claim 11, wherein the code substitution operation comprises:
a first substitution operation, which simply substitutes a syntax element of the conversion target portion with a RISC-V-based corresponding element at a same location as a location of the conversion target portion; or
a second substitution operation, which inserts the RISC-V-based corresponding element substituted from the syntax element of the conversion target portion at a different location in the first code from the location of the conversion target portion.

15. The code conversion method of claim 11, wherein the code modification operation comprises:
a first modification operation to add another code to a syntax element of the conversion target portion;
a second modification operation to change part of a syntax of a syntax element of the conversion target portion;
a third modification operation to change an entire syntax of a syntax element of the conversion target portion;
a fourth modification operation to add code according to an additional logic to the first code; or
a fifth modification operation to replace a syntax element of the first code with code according to an additional logic.

16. The code conversion method of claim 11, wherein the presentation operation comprises at least one of:
a first presentation operation of outputting information comprising example code analogous to a syntax element of the conversion target portion; or
a second presentation operation of outputting information comprising an implementation concept for a syntax element of the conversion target portion.

17. The code conversion method of claim 11, wherein the generating of the second code comprises:
integrating, with other portions of the first code, syntax elements that are converted by applying, to the conversion target portion, the code substitution operation or the code modification operation.

18. The code conversion method of claim 17, wherein the code substitution operation or the code modification operation is performed by accessing a conversion table mapping standard items, including the standard item, of the ARM architecture, to corresponding items, including the corresponding item, of the RISC-V architecture.

19. The code conversion method of claim 11, further comprising:
compiling the second code into binary code by using a RISC-V compiler; and
obtaining verification information on the binary code based on a result of execution of the binary code in a RISC-V simulator environment or a RISC-V hardware environment.

20. A non-transitory computer-readable storage medium storing instructions that, when executed by a processor, cause the one or more processors to perform the method of claim 11.
